(19) United States
(12) Patent Application Publication
(10) Pub. No.: US 2022/0311711 A1
(43) Pub. Date: Sep. 29, 2022

(54) CONGESTION CONTROL BASED ON NETWORK TELEMETRY

(71) Applicant: Intel Corporation, Santa Clara, CA (US)

(72) Inventors: Theodore JEPSEN, Los Altos Hills, CA (US); Junggun LEE, Los Altos, CA (US); Grzegorz JERECZEK, Gdansk (PL); Simon WASS, Gdansk (PL)

(21) Appl. No.: 17/839,393

(22) Filed: Jun. 13, 2022

Related U.S. Application Data
(63) Continuation-in-part of application No. 17/482,822, filed on Sep. 23, 2021.
(60) Provisional application No. 63/340,297, filed on May 10, 2022.

(51) Int. Cl. H04L 47/25; H04L 47/12; H04L 47/27; H04L 47/30; H04L 47/10

(52) U.S. Cl. CPC H04L 47/25; H04L 47/12; H04L 47/27; H04L 47/30; H04L 47/18

(57) ABSTRACT

Examples described herein relate to a network interface device that includes circuitry to: adjust a rate of packet transmissions by Explicit Congestion Notification (ECN)-based congestion control based on phase of operation and congestion metrics comprising queue depth at one or more intermediate switches. In some examples, the circuitry is to adjust the rate of packet transmissions by multiplicative decrease or increase based on a number of inflight bytes. In some examples, the circuitry is to adjust the rate of packet transmissions by additive decrease or increase based on congestion metric from the one or more intermediate switches at one or more intermediate switches.

### RELATED APPLICATION

This application claims priority to U.S. Provisional Application No. 63/340,297, filed May 10, 2022. The entire contents of that application is incorporated by reference in its entirety.

This application is a continuation-in-part of and claims priority to U.S. application Ser. No. 17/482,822, filed Sep. 23, 2021 (Attorney docket No AD2901-US). The entire contents of that application is incorporated by reference in its entirety.

### BACKGROUND

Data centers provide vast processing, storage, and networking resources to users. For example, automobiles, smart phones, laptops, tablet computers, or internet of things (IoT) devices can leverage data centers to perform data analysis, data storage, or data retrieval. Data centers are typically connected together using high speed networking devices such as network interfaces, switches, or routers. In a data center, end-to-end (E2E) congestion control is deployed to detect network congestion and react to congestion by lowering the per-flow or per-connection transmission bytes or windows.

Priority Flow Control (PFC) is a network flow control solution described in Institute of Electrical and Electronics Engineers (IEEE) standard 802.1Qbb-2011, which is part of the framework for the IEEE 802.1 Data Center Bridging (DCB) interface. PFC enables flow control over a unified IEEE 802.3 Ethernet media interface, or fabric, for local area network (LAN) and storage area network (SAN) technologies. PFC can reduce packet loss arising from congestion on a network link by reducing a rate of packet transmission. Packet loss-sensitive protocols, such as Fibre Channel over Ethernet (FCoE), can coexist with packet loss-insensitive protocols using a same unified fabric. PFC can reduce congestion-related packet drops but can incur side effects such as PFC storm, deadlock, and Head-of-Line blocking in fabric links, which can lower network fabric bandwidth. In some cases, E2E congestion control is too slow to detect and react to congestion in sub-round trip time (RTT).

### BRIEF DESCRIPTION OF THE DRAWINGS

FIG. 1 depicts an example system.

FIG. 2 depicts example performance data.

FIG. 3 depicts an example process.

FIG. 4 depicts an example process.

FIG. 5 depicts an example process.

FIG. 6 depicts an example process.

FIG. 7 depicts an example switch.

FIG. 8 depicts an example network interface.

FIG. 9 depicts an example system.

### DETAILED DESCRIPTION

Some of the factors affecting the performance of modern datacenter applications are network latency and packet throughput. For some applications, the underlying transport is Transmission Control Protocol (TCP). Multiple different congestion control (CC) schemes are utilized for TCP. Explicit Congestion Notification (ECN), defined in RFC 3168 (2001), allows end-to-end notification of network congestion whereby the receiver of a packet echoes a congestion indication to a sender. A packet sender can reduce its packet transmission rate in response to receipt of an ECN. Use of ECN can lead to packet drops if detection and response to congestion is slow or delayed. TCP CC is based on heuristics from measures of congestion such as network latency or the number of packet drops.

Other TCP congestion control algorithms include ECN-based congestion control such as Google's Swift, Amazon's SRD, and Data Center TCP (DCTCP), described for example in RFC-8257 (2017). DCTCP is a TCP congestion control scheme whereby when a buffer reaches a threshold, packets are marked with ECN and the end host receives markings and notifies the sender of congestion in acknowledgement packets. The sender adjusts its congestion window (CWND) size to adjust a number of sent packets for which acknowledgement of receipt was not received. In response to an ECN, a sender can reduce a CWND size to reduce a number of sent packets for which acknowledgement of receipt was not received. Swift, SRD, DCTCP, and other CC schemes adjust CWND size based on indirect congestion metrics such as packet drops or network latency.

High Precision Congestion Control (HPCC) is a congestion control system utilized for remote direct memory access (RDMA) communications that provides congestion metrics to convey precise link load information. HPCC is described at least in Li et al., “HPCC: High Precision Congestion Control,” SIGCOMM (2019). HPCC leverages in-network telemetry (INT) (e.g., Internet Engineering Task Force (IETF) draft-kumar-ippm-ifa-01, “Inband Flow Analyzer” (February 2019)). HPCC uses in-band telemetry INT to provide congestion metrics measured at intermediary switches.

As described herein, a sender network interface device can utilize one or more DCTCP CC schemes to adjust packet transmission rates based on network resource consumption data (e.g., congestion metrics) from one or more intermediary switch devices at slow start or in response to an indication of congestion. Utilized DCTCP CC schemes can be based on queue depth information or utilization level. For example, the sender network interface device can change packet transmit rate by multiplicative decrease or increase based on a U metric (e.g., normalized inflight bytes) or based on a-parameter, described herein, by additive or multiplicative decrease or increase. A rate of packet transmit rate adjustment can represent how quickly the sender network interface device increases packet transmit rate in response to congestion decreasing or how quickly the sender network interface device decreases packet transmit rate based on congestion increasing. In some examples, a transmit rate can be controlled based on a size of a CWND (e.g., number of inflight bytes). The sender network interface device can utilize legacy DCTCP CC if ECN markings are provided and a switch does not provide network resource consumption data. Network resource consumption data can include one or more of: queue depth, link utilization, number of flows that provide packets to a congested queue, most congested queue depth in switches along a path from sender to receiver, most congested switch identifier (ID), end-to-end (E2E) latency, number of flows that provide packets to a congested queue, and others. Network resource consumption data can be conveyed in one or more TCP headers, INT, or other manners.

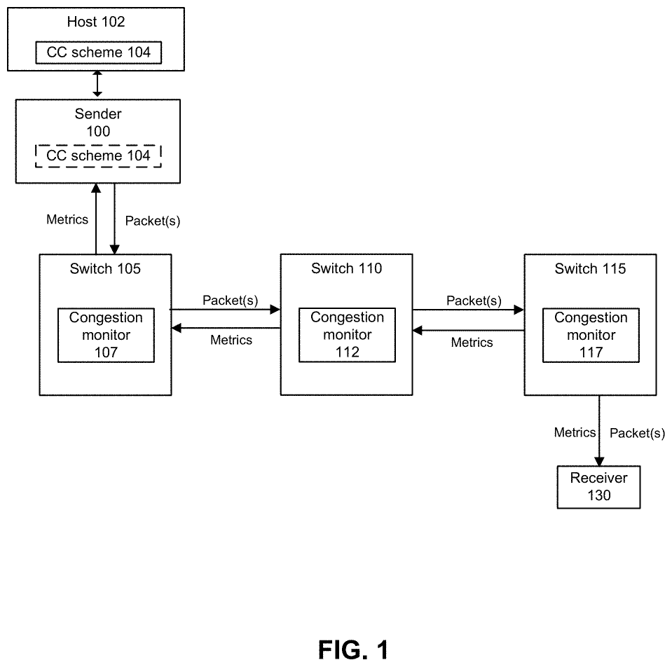

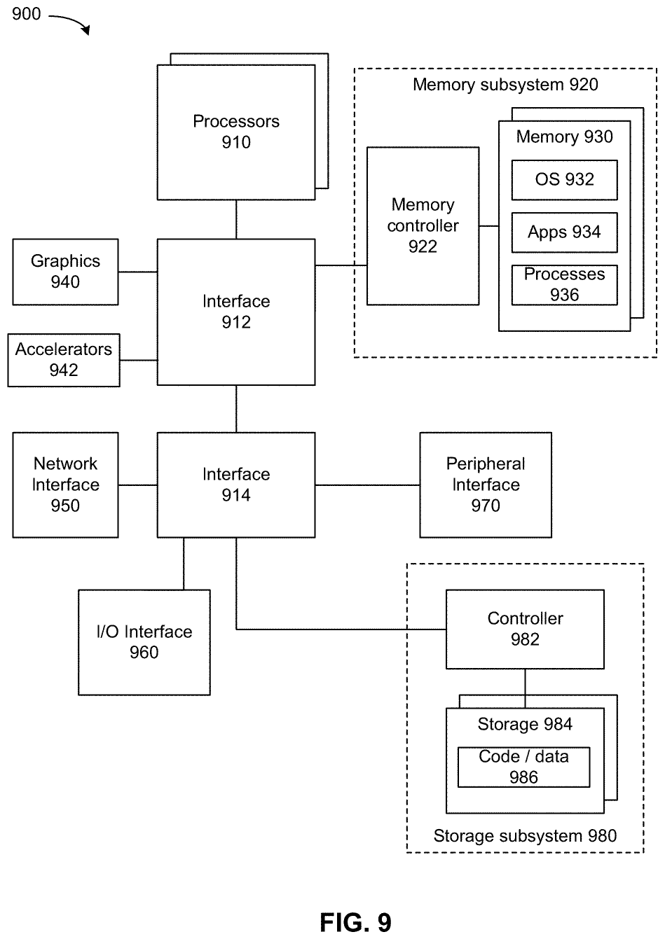

FIG. 1 depicts an example system. Sender 100 can include a network interface device that sends one or more packets to receiver 130, via switch 110, at a request of host system 102. A sender host system 102 can execute an operating system (OS) (not shown) that supports processing transmissions and receipt of packets in accordance with TCP. An example host 102 is described in FIG. 9 and host 102 can include elements of the system of FIG. 9. A packet may be used herein to refer to various formatted collections of bits that may be sent across a network, such as Ethernet frames, IP packets, Transmission Control Protocol (TCP) segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

A flow can be a sequence of packets being transferred between two endpoints, generally representing a single session using a protocol. Accordingly, a flow can be identified by a set of defined tuples and, for routing purpose, a flow is identified by the two tuples that identify the endpoints, i.e., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

In some examples, switch 115 can be positioned as a last-hop switch before receiver 130. A programmable packet processing pipeline of switch 115 can perform congestion monitor 117 to track per-egress-port and/or per-queue congestion metrics. Congestion metrics can represent one or more of: level of congestion, queue depth, link utilization available bandwidth (BW), or current transmit (TX) rate. Available BW can include TX rate, queuing latency, queue draining/pause time, per-egress-queue arrival rates measured at ingress, link utilization and/or remaining BW. TX rate can be represented per-queue or for a queue and higher-priority queues. Available BW can represent link speed or a total TX rate of a sum of TX rates of queues that provided packets to egress from a port.

Switch 115 can provide congestion metrics, observed and processed, by congestion monitor 117 of switch 115 at least to sender 100 and/or receiver 130 in response to one or more of: receipt of a control message, congestion control by a queueing system of switch 115 or flow control schemes. Switch 115 can send congestion metrics to one or more other sender devices in addition to sender 100, where such sender devices send packets to a port or queue of switch 110 that is identified to be congested.

For example, switch 115 can send one or more congestion metrics to sender 100 and/or receiver 130 via one or more packets allocated in a high-priority queue. For example, switch 115 can send one or more congestion metrics to sender 100 by embedding one or more congestion metrics in one or more packets in accordance with one or more of: congestion protocols such as Data Center Quantized Congestion Notification (DCQCN), High-Precision Congestion Control (HPCC), Receiver-based High-Precision Congestion Control (RX-HPCC) utilizing network constructs such as Congestion Notification Packets (CNPs), In-band Network Telemetry (INT) (e.g., P4.org Applications Working Group, “In-band Network Telemetry (INT) Dataplane Specification,” Version 2.1 (2020)), Round-Trip-Time (RTT) probes, acknowledgement (ACK) messages, IETF draft-lapukhov-dataplane-probe-01, “Data-plane probe for in-band telemetry collection” (2016); IETF draft-ietf-ippm-ioam-data-09, “In-situ Operations, Administration, and Maintenance (IOAM)” (Mar. 8, 2020), and so forth. Transmitted data packets can carry congestion metrics from a switch (e.g., switch 115) to sender 100 and/or receiver 130. In some examples, switch 115 can provide congestion metrics with location identifiers (IDs) such as switch ID, IP time to live (TTL) (e.g., identify switch that sends congestion metrics based on number of traversed hops), or IP address, port number, or queue number.

Switch 105 can include packet processing circuitry that implements a congestion monitor 107 that performs similar operations as those of congestion monitor 117 of switch 115 except for switch 105. Similarly, switch 110 can include packet processing circuitry that implements a congestion monitor 112 that performs similar operations as those of congestion monitor 117 of switch 115 except for switch 110.

For congestion metrics sent by a switch 115 to switch 110, switch 110 can propagate congestion metrics observed by congestion monitor 112 to switch 105 where congestion metrics observed by congestion monitor 112 are greater (indicate more congestion) than those received from switch 115. Otherwise, switch 110 can propagate congestion metrics from switch 115. Similarly, switch 105, in a forwarding path from switch 110 to sender 100, can compare its current value of congestion metrics against received congestion metrics. If the congestion metrics are less than congestion metrics observed by congestion monitor 107 of switch 105, switch 105 can propagate congestion metrics observed by congestion monitor 107 of switch 105 to sender 100. Otherwise, switch 105 can propagate congestion metrics from switch 110.

In some examples, one or more of congestion monitor 107, 112, or 117 can determine and propagate congestion metrics based on one or more of the following arithmetic operations: maximum, minimum, summation, count, or average. For example, one or more of congestion monitor 107, 112, or 117 can determine and provide, as part of congestion metrics, a maximum of queue depth (e.g., enqueue or dequeue time) computed for an associated switch 105, 110, or 115 and that received in a packet. For example, one or more of congestion monitor 107, 112, or 117 can determine and provide, as part of congestion metrics, a maximum of queue time (measured or expected) computed for an associated switch 105, 110, or 115 and that received in a packet.

For example, one or more of congestion monitor 107, 112, or 117 can determine and provide, as part of congestion metrics, a summation of queueing time received in a packet with a queueing time for a packet in a queue. In other words, congestion metrics conveyed in a packet header can be added or summed with a queueing time experienced in the current switch.

For example, one or more of congestion monitor 107, 112, or 117 can determine and provide, as part of congestion metrics, a minimum of transmit rate from a queue or port computed for an associated switch 105, 110, or 115 and that received in a packet to determine a congested link between nodes as a lowest transmit rate link can represent a bottleneck. For example, one or more of congestion monitor 107, 112, or 117 can determine and provide, as part of congestion metrics, a minimum of available bandwidth (e.g., line_rate—transmit rate) from a queue or port computed for an associated switch 105, 110, or 115 and that received in a packet to determine a congested link between nodes.

While examples are described with respect to switch 115 providing congestion metrics to sender 100 though switches 110 and 105, switch 110 can provide congestion metrics to switch 105 and switch 105 can forward congestion metrics from switch 110 if such congestion metrics are higher than congestion metrics generated by switch 105.

One or more intermediate switches (e.g., 105 to 115) in a path between sender network interface device 100 and receiver network interface device 130 can be configured to change the congestion metric update interval for TCP/IP flows in order to increase or decrease the granularity and speed of congestion metric updates (e.g., network resource consumption data) or reduce the system overhead on end-hosts that process congestion metrics. A congestion metric update interval can be adjusted dynamically based on a number of flows that provide packets to a queue or port for which congestion metrics are reported. A switch can perform flow counting to determine a number of flows that provide packets to a queue or port for which congestion metrics are reported. For example, a packet processing pipeline of a switch can report congestion metrics or telemetry at a frequency in proportion to a number of flows that provide packets to a congested queue or port. A higher number of flows can lead to a higher frequency of congestion metric reporting by one or more switches, whereas a lower number of flows can lead to a lower frequency of congestion metric reporting by one or more switches. A number of reported flows can be used by sender to adjust observed Iratio, where Iratio can represent a frequency of reporting congestion metrics by one or more switches. The sender can adjust Iratio utilized by switch via one or more packets in a control plane or data plane.

Switch 105, 110, and/or 115 can be implemented as one or more of: network interface controller (NIC), SmartNIC, router, top of rack (ToR) switch, switch, forwarding element, infrastructure processing unit (IPU), or data processing unit (DPU). Congestion monitor 107, 112, and/or 117 can be implemented using one or more of: packet processing pipeline programmed using a packet processing pipeline language (e.g., one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others), processor that perform instructions, application specific integrated circuits (ASICs), field programmable gate arrays (FPGAs), and/or other circuitry.

Based on received congestion metrics, host system 102 can perform a congestion control scheme 104. For example, host system 102 can load Extended Berkeley Packet Filter (eBPF) CC scheme 104 at runtime. Alternatives to eBPF include kernel module or adjusting the networking stack in the operating system (OS). Sender network interface device 100 can provide congestion metrics to a eBPF module in network stack in an OS. CC scheme 104 can extract congestion metrics data per-flow to detect current utilization or queue depth and can adjust CWND of sender 100 based on congestion metrics. Various examples of adjustment of CWND based on congestion metrics are described herein. In some examples, sender network interface device can perform CC scheme 104 by a programmable processor.

Examples can be used for performant reliable transport (RT) for data storage communications as well as microservice-to-microservice communications, video streaming, and others. Examples described herein can provide performant TCP with HPTCP.

For example, CC scheme 104 can adjust CWND based on an alpha (α) value, where the alpha value can be selected from a larger of an alpha value (αᵢₙₜ) or α_{DCTCP}. α_{DCTCP} is described in DCTCP at in section 3.3 of RFC 8257 (2017) (e.g., DCTCP.Alpha). The value of α can represent a fraction above a target queue depth.

In some examples, α=max(α_{DCTCP}, αᵢₙₜ), where

αᵢₙₜ=qdepth_{smoothed}/qdepth_{threshold},

qdepth_{smoothed} is updated to (1−g)*qdepth_{smoothed}+g*qdepth,

qdepth_{smoothed} is initialized to 0,

qdepth=qdepth received in congestion metrics,

g=smoothing or decay factor that is <1 and controls a weight of a latest observed qdepth, compared to the previous observations,

qdepth_{threshold}=ECN marking threshold or upper level queue depth.

Accordingly, at least as described in section 3.3 of RFC 8257 (2017), a congestion window can be adjusted based on α as CWND=CWND*(1−α=max(α_{DCTCP}, αᵢₙₜ)/2). By use of alpha value selected from a larger of an alpha value (αᵢₙₜ) or α_{DCTCP}, CC scheme 104 can change CWND by additive decrease or increase. The amount of CWND decrease as defined by a can be based on precise congestion signal (e.g., queue depth (qdepth as provided by network resource consumption data), where provided, instead of ECN markings. Using a higher α value can provide faster reaction to congestion at least when using DCTCP by reacting to a first packet carrying queue congestion information instead of waiting for a number of ECN marked packets to signal congestion. Legacy α_{DCTCP} can be used if congestion occurs on a switch that does not report network resource consumption to sender 100. CC scheme 104 can monitor α_{DCTCP} and acted upon by decreasing a legacy DCTCP adaptive congestion window to reduce congestion on network devices that only support ECN marking.

A change in CWND size can be based on a number of flows contributing to congestion at a queue. For example, CC scheme 104 can adjust a CWND based on a number of reported flows that contribute packets to a congested queue or congested port so that a flow is allocated a fair share of adjustment to CWND. For example, CWND additive increase parameter (W_{AI}) can be adjusted based on number of reported flows. When there are few flows, the CWND can be updated more aggressively for a flow. When there are more flows, the CWND can be updated less aggressively for a flow. However, CWND size adjustments for flows can be made independently for flows.

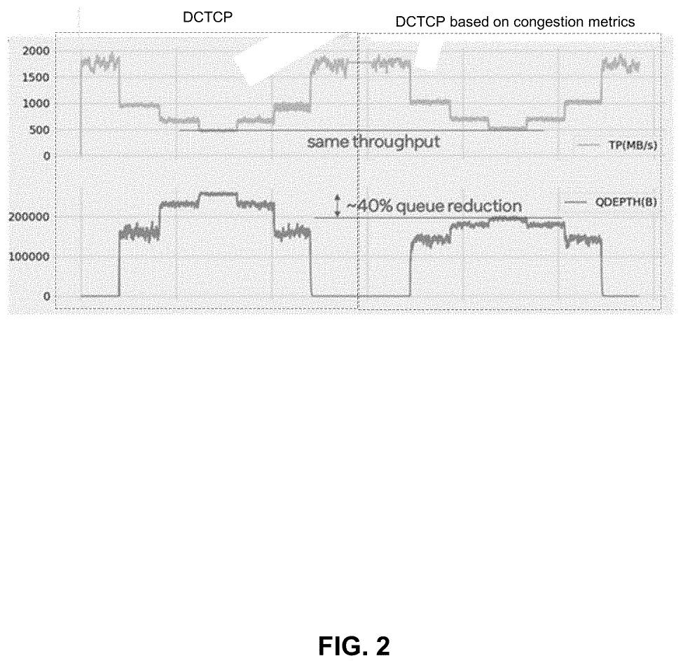

FIG. 2 depicts example performance data. For DCTCP using CC scheme 104 based on the larger alpha value (αᵢₙₜ) or α_{DCTCP} and DCTCP CC throughput levels can be similar. For DCTCP using CC scheme 104 based on the larger alpha value (αᵢₙₜ) or α_{DCTCP}, queue depth reduction can be approximately 40% relative to queue depth from DCTCP CC. Reduction in transmit rate at endpoint sender can be more precise.

A TCP slow start phase can occur when a network interface device commences transmitting packets without information on network congestion. For TCP slow start and TCP-congestion-avoidance phases, DCTCP relies on the standard TCP Reno algorithm described in at least section 3.4 of RFC 5681 (2017) for increasing CWND until packet loss occurs. During a TCP slow start phase, CWND may increase at a rate that is lower than the network can transfer packets without congestion.

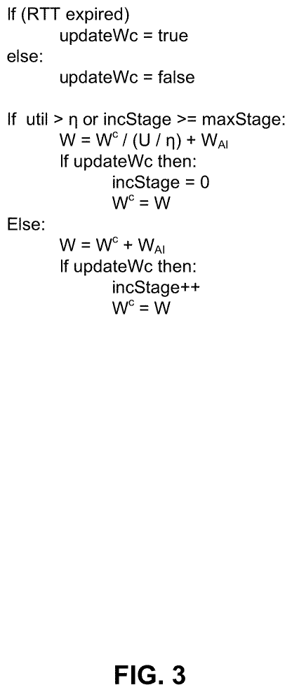

FIG. 3 depicts an example pseudocode to adjust a size of a congestion window size utilized by a sender network interface device based on congestion metrics during TCP slow start. A congestion control scheme can perform a multiplicative increase at TCP slow start for a DCTCP connection can occur based on utilization and window size adjustment congestion metrics. Congestion metrics can provide current link utilization of a network port with highest congestion in a network path from a sender to receiver. However, if congestion is detected (e.g., by ECN-based α_{DCTCP} or qdepth-based αᵢₙₜ), the sender can resort back to the adaptive window decreases, using congestion avoidance using at least standard TCP Reno algorithm described in at least section 3.4 of RFC 5681 (2017), to decrease CWND size.

In the pseudocode, W can represent congestion or sending window that limits number of inflight bytes sent by a sender network interface device. Round trip time (RTT) can represent a time between transmission of a packet and time of receipt for an associated receipt acknowledgement (ACK) by a sender network interface device. Based on expiration of RTT or at a time interval of RTT, a window can be adjusted. However, if an RTT has not expired, the window may not be adjusted. If utilization is greater than η, or a current stage number is greater than or equal to a maxStage parameter, the window size can be adjusted multiplicatively to be W=W^{c}/(U/η)+W_{AI}. Parameter U is described herein or at least in HPCC equation (2) (e.g., Li et al., “HPCC: High Precision Congestion Control,” SIGCOMM (2019)). Parameters η, maxStage, W^{c}, and W_{AI} are described at least in HPCC (e.g., Li et al., “HPCC: High Precision Congestion Control,” SIGCOMM (2019)). For example, parameter η can represent a target utilization and can control how close the target send rate is to the link capacity. In some examples, parameter η can be set to 95%, although other values can be used. For example, parameter maxStage can represent a number of tradeoff between steady state stability and the speed to reclaim free bandwidth. For example, parameter W^{c} can represent a reference window size, a runtime state updated on a per-RTT basis. For example, parameter W_{AI} can represent an additive increase parameter.

However, if utilization is not greater than η and a stage is not more than or equal to a maximum stage (e.g., 5), then window size can be increased by an additive increase parameter W_{AI} and stage number (incStage) can be incremented by one.

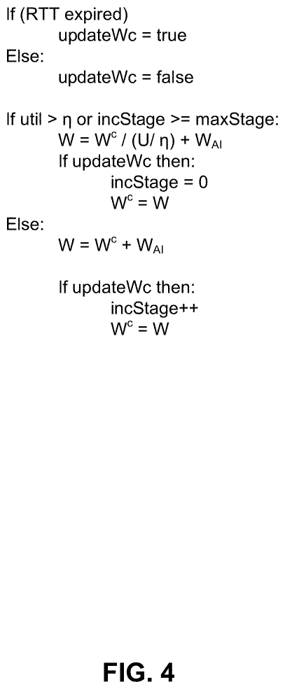

FIG. 4 depicts an example of pseudocode to adjust a congestion window size utilized by a sender network interface device. A congestion control scheme can change CWND by multiplicative decrease or increase based on U value. The U value can be determined as follows.

sFactor=1

txRate*b becomes txRate/B=util

qlen*a becomes qdepth/B*T=qdepth/BDP

U=qdepth/BDP+util, where:
Bandwidth*Delay Product (BDP) can indicate an amount of data that can be in transit in the network. BDP can be a product of the available bandwidth and the latency (e.g., RTT),
util=utilization from received congestion metrics (e.g., percentage of bandwidth used, which 100% if there is queueing),

U can substituted with U_{smoothed}, where U_{smoothed} can be set to (1−g)* U_{smoothed}+g*U, where g represents smoothing factor.

One or more switches (e.g., switches 105, 110, or 115) can calculate glen or qdepth and link utilization and provide these metrics to sender 100 and host 102. Variables glen and qdepth can represent queue occupancy level on a congested link. For example, if link utilization is 100 percent or more, then a switch can provide qdepth in congestion metrics sent to sender 100 and host 102. Queueing can occur based on full link utilization and if link utilization is less than 100%, then a switch can provide just link utilization value in congestion metrics.

In some examples, qdepth can indicate a highest qdepth observed in the network by switches in a path from sender to receiver, while utilization can indicate link utilization of the egress port or queue on which this highest qdepth is encountered. In some examples, a highest bit of U value can indicate whether a link utilization value carries link utilization or queue depth. In some examples, at a switch, a precision of a link utilization value can be adjusted to fit within fewer bits by dropping least significant bits (LSBs)). Accordingly, less bandwidth overhead can be incurred by transmitting qdepth or link utilization, but not both, and by truncating link utilization value.

In some examples, the pseudocode of FIG. 4 can be used by a sender network interface device for a slow start operation if network resource consumption data are available and qdepth is provided or for other TCP congestion states such as congestion avoidance phase. Referring to the pseudocode of FIG. 4, W can represent congestion or sending window that limits number of inflight bytes sent by a sender network interface device. Based on expiration of RTT, a window size can be adjusted. If utilization is greater than η or a current stage is greater than or equal to maxStage, the window size can be adjusted multiplicatively to be W=W^{c}/(U/η)+W_{AI}. Parameters maxStage, W^{c}, and W_{AI} are described at least in HPCC (e.g., Li et al., “HPCC: High Precision Congestion Control,” SIGCOMM (2019)).

However, if utilization is not greater than η and a stage is less than a maxStage, then the window size can be increased by an additive increase parameter W_{AI} and a stage number (incStage) can be incremented by one.

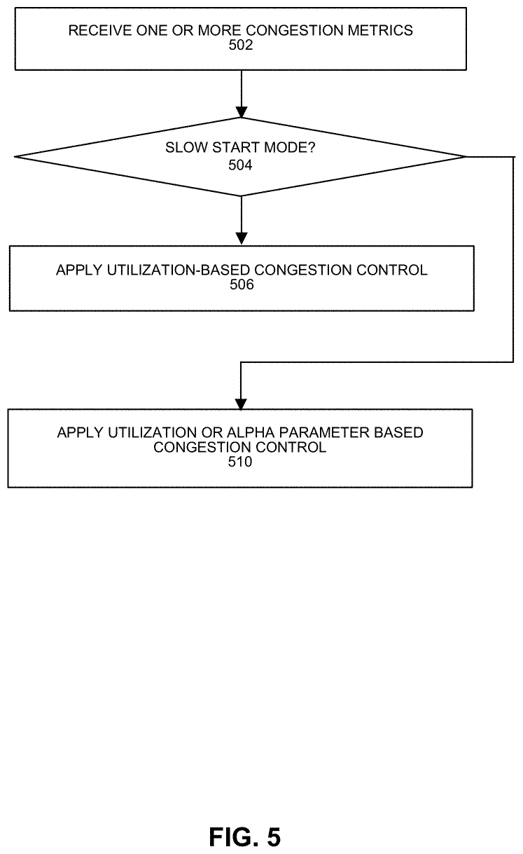

FIG. 5 depicts a process that can be performed as part of congestion control. The process can be performed by a sender network interface device and/or host system connected to the sender network interface device. The process can be performed by a congestion control scheme based on DCTCP. At 502, one or more congestion metrics can be received at a sender network interface device. The one or more congestion metrics can be received from a switch in a path of packet traffic from the sender network interface device to a receiver network interface device. The one or more congestion metrics can include data to indicate link utilization or queue depth of at least one switch in the path. Congestion metrics can include one or more of: level of congestion, queue depth, link utilization available bandwidth (BW), or current transmit (TX) rate. Available BW can include TX rate, queuing latency, queue draining/pause time, per-egress-queue arrival rates measured at ingress, link utilization, and/or remaining BW. At 504, a determination can be made if the sender network interface device is operating in slow start phase. Based on the sender network interface device operating in slow start phase, the process can proceed to 506. Based on the sender network interface device not operating in slow start mode, such as congestion-avoidance phase, the process can proceed to 510.

At 506, a congestion control scheme can be used to adjust a packet transmit rate of packets. For example, the packet transmit rate of packets sent to the queue or port of the switch that provided congestion metrics can be adjusted. Adjustment of a packet transmit rate can occur based on increase or decrease of a size of a congestion window. As described herein, where congestion metrics include data related to a utilization level, the congestion window can be adjusted based on utilization level or U metric.

At 510, a congestion control scheme can be used to adjust a packet transmit rate of packets. Adjustment of a packet transmit rate can occur based on increase or decrease of a size of a congestion window. Adjustment of a congestion window size can be multiplicatively adjusted based on utilization or additively adjusted based on an α-parameter as described herein. A sender network interface device and/or host system can choose whether to adjust congestion window size multiplicatively based on utilization or additively or multiplicatively based on an α-parameter.

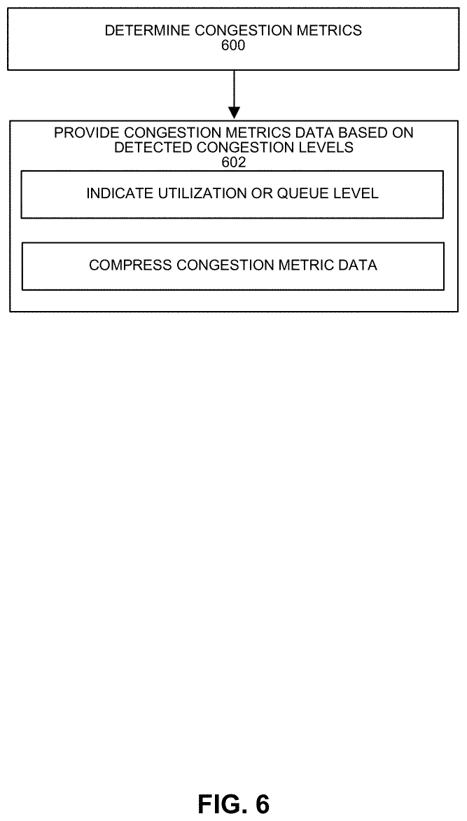

FIG. 6 depicts an example process. The process can be performed by one or more switches. At 600, one or more congestion metrics can be determined. For example, a programmable packet processing pipeline can be configured to determine congestion metrics. At 602, the one or more congestion metrics can be sent to a sender network interface device. For example, the one or more congestion metrics can indicate link utilization or queue level (but not both). In some examples, one or more congestion metrics can be truncated or compressed. For example, link utilization can be truncated or compressed. In some examples, congestion metrics can be determined and/or provided at a frequency in proportion to a number of flows that provide packets to a congested queue or port.

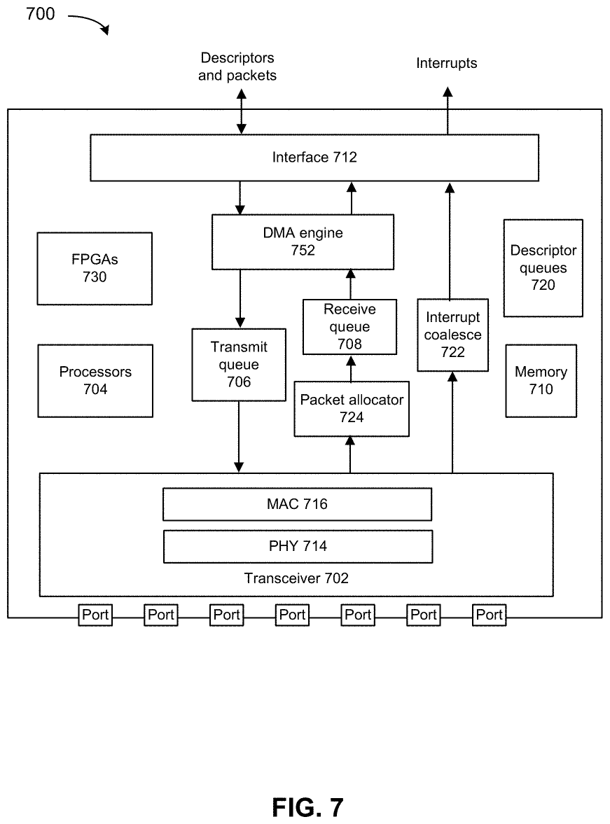

FIG. 7 depicts an example network interface device. In some examples, processors 704 and/or FPGAs 740 can be configured to apply a DCTCP congestion scheme to adjust a congestion window at a rate based on phase of operation (e.g., slow start or congestion-avoidance phase) as well as congestion metrics, as described herein. Some examples of network interface 700 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 700 can include transceiver 702, processors 704, transmit queue 706, receive queue 708, memory 710, and bus interface 712, and DMA engine 752. Transceiver 702 can be capable of receiving and transmitting packets in conformance with the applicable protocols such as Ethernet as described in IEEE 802.3, although other protocols may be used. Transceiver 702 can receive and transmit packets from and to a network via a network medium (not depicted). Transceiver 702 can include PHY circuitry 714 and media access control (MAC) circuitry 716. PHY circuitry 714 can include encoding and decoding circuitry (not shown) to encode and decode data packets according to applicable physical layer specifications or standards. MAC circuitry 716 can be configured to perform MAC address filtering on received packets, process MAC headers of received packets by verifying data integrity, remove preambles and padding, and provide packet content for processing by higher layers. MAC circuitry 716 can be configured to assemble data to be transmitted into packets, that include destination and source addresses along with network control information and error detection hash values.

Processors 704 can be one or more of: combination of: a processor, core, graphics processing unit (GPU), field programmable gate array (FPGA), application specific integrated circuit (ASIC), or other programmable hardware device that allow programming of network interface 700. For example, a “smart network interface” or SmartNIC can provide packet processing capabilities in the network interface using processors 704.

Processors 704 can include a programmable processing pipeline that is programmable by one or more of: Programming Protocol-independent Packet Processors (P4), SONiC, C, Python, Broadcom Network Programming Language (NPL), NVIDIA® CUDA®, NVIDIA® DOCA™, Infrastructure Programmer Development Kit (IPDK), or ×86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 704 and/or FPGAs 740 can be configured to perform event detection and action.

Packet allocator 724 can provide distribution of received packets for processing by multiple CPUs or cores using receive side scaling (RSS). When packet allocator 724 uses RSS, packet allocator 724 can calculate a hash or make another determination based on contents of a received packet to determine which CPU or core is to process a packet.

Interrupt coalesce 722 can perform interrupt moderation whereby network interface interrupt coalesce 722 waits for multiple packets to arrive, or for a time-out to expire, before generating an interrupt to host system to process received packet(s). Receive Segment Coalescing (RSC) can be performed by network interface 700 whereby portions of incoming packets are combined into segments of a packet. Network interface 700 provides this coalesced packet to an application.

Direct memory access (DMA) engine 752 can copy a packet header, packet payload, and/or descriptor directly from host memory to the network interface or vice versa, instead of copying the packet to an intermediate buffer at the host and then using another copy operation from the intermediate buffer to the destination buffer.

Memory 710 can be any type of volatile or non-volatile memory device and can store any queue or instructions used to program network interface 700. Transmit traffic manager can schedule transmission of packets from transmit queue 706. Transmit queue 706 can include data or references to data for transmission by network interface. Receive queue 708 can include data or references to data that was received by network interface from a network. Descriptor queues 720 can include descriptors that reference data or packets in transmit queue 706 or receive queue 708. Bus interface 712 can provide an interface with host device (not depicted). For example, bus interface 712 can be compatible with or based at least in part on PCI, PCIe, PCI-x, Serial ATA, and/or USB (although other interconnection standards may be used), or proprietary variations thereof.

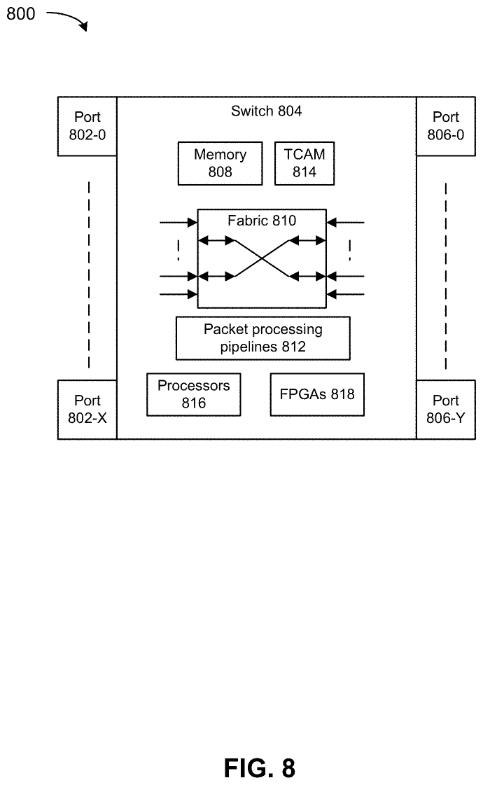

FIG. 8 depicts an example switch. For example, components of the switch can be implemented as an integrated circuit, integrated circuits coupled by interconnects, and/or a system on chip (SoC). Various examples can be used in or with the switch to determine and transmit congestion metrics at a frequency, as described herein. Switch can receive a single packet from the source and sends one copy to each one of the recipients. Switch 800 can route packets or frames of any format or in accordance with any specification from any port 802-0 to 802-X to any of ports 806-0 to 806-Y (or vice versa). Any of ports 802-0 to 802-X can be connected to a network of one or more interconnected devices. Similarly, any of ports 806-0 to 806-Y can be connected to a network of one or more interconnected devices.

In some examples, switch fabric 810 can provide routing of packets from one or more ingress ports for processing prior to egress from switch 800. Switch fabric 810 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 808 can be configured to store packets received at ports prior to egress from one or more ports. Packet processing pipelines 812 can determine which port to transfer packets or frames to using a table that maps packet characteristics with an associated output port. Packet processing pipelines 812 can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines 812 can implement access control list (ACL) or packet drops due to queue overflow. As described herein, packet processing pipelines 812, processors 816, and/or FPGA 818 can be configured to (a) determine, per-egress-port and/or queue, congestion metrics to represent (i) level of congestion and (ii) available bandwidth (BW) or current transmit (TX) rate and (b) cause transmission of congestion metrics to a sender or receiver, as described herein. Congestion metrics can be determined based on receipt of a control message or other triggers such as congestion notification or determination of congestion at a port or queue.

Configuration of operation of packet processing pipelines 812, processors 816, and/or FPGA 818 can be programmed using one or more of: P4, SONiC, C, Python, Broadcom Network Programming Language (NPL), NVIDIA® CUDA®, NVIDIA® DOCA™, Infrastructure Programmer Development Kit (IPDK), or ×86 compatible executable binaries or other executable binaries. Processors 816 and FPGAs 818 can be utilized for packet processing or modification.

FIG. 9 depicts an example system. Components of system 900 (e.g., processor 910, accelerators 942, network interface 950, and so forth) can be configured to apply a DCTCP congestion scheme to adjust a congestion window at a rate based on phase of operation (e.g., slow start or congestion-avoidance phase) as well as congestion metrics, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

OS 932 and/or a driver for network interface 950 can configure network interface 950 to apply a DCTCP congestion scheme to adjust a congestion window at a rate based on phase of operation (e.g., slow start or congestion-avoidance phase) as well as congestion metrics, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Network interface 950 can include one or more of: a network interface controller (NIC), a remote direct memory access (RDMA)-enabled NIC, SmartNIC, router, switch, or network-attached appliance. Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., Non-Volatile Memory Express (NVMe) Specification, revision 1.3c, published on May 24, 2018 or earlier or later versions, or revisions thereof).

Communications between devices can take place using a network that provides die-to-die communications; chip-to-chip communications; circuit board-to-circuit board communications; and/or package-to-package communications.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network interface device that includes circuitry to: adjust a rate of packet transmissions by Explicit Congestion Notification (ECN)-based congestion control based on phase of operation and congestion metrics comprising queue depth at one or more intermediate switches.

Example 2 includes one or more examples, wherein the circuitry is to adjust the rate of packet transmissions by multiplicative decrease or increase based on a number of inflight bytes.

Example 3 includes one or more examples, wherein the circuitry is to adjust the rate of packet transmissions by additive decrease or increase based on congestion metric from the one or more intermediate switches at one or more intermediate switches.

Example 4 includes one or more examples, wherein the adjust the rate of packet transmissions by additive decrease or increase based on queue depth is based on Explicit Congestion Notification (ECN) indications or smoothed queue depth and queue depth threshold.

Example 5 includes one or more examples, wherein the circuitry is to fall back to Data Center TCP (DCTCP) congestion control based on unavailability of queue depth.

Example 6 includes one or more examples, wherein the rate of packet transmissions is based on a congestion window size.

Example 7 includes one or more examples, wherein the circuitry is to adjust the congestion window size based on a number of flows contributing to congestion.

Example 8 includes one or more examples, wherein the network resource consumption data includes one or more of: queue depth, link utilization, or number of flows that provide packets to a congested queue.

Example 9 includes one or more examples, wherein the phase of operation comprises slow start or congestion-avoidance phase.

Example 10 includes one or more examples, wherein the network interface device comprises one or more of: network interface controller (NIC), SmartNIC, router, forwarding element, infrastructure processing unit (IPU), or data processing unit (DPU).

Example 11 includes one or more examples, and including a computing system coupled to the network interface device, wherein the computing system is to configure a congestion window size of the network interface device to adjust a rate of packet transmissions by DCTCP congestion control.

Example 12 includes one or more examples, and includes one or more switches to provide the congestion metrics at a frequency based on a number of flows contributing to congestion.

Example 13 includes one or more examples, and includes a computer-readable medium comprising instructions stored thereon, that if executed by one or more processors, cause the one or more processors to: configure circuitry of a network interface device to: adjust a rate of packet transmissions by Explicit Congestion Notification (ECN)-based congestion control based on phase of operation and congestion metrics comprising queue depth at one or more intermediate switches.

Example 14 includes one or more examples, wherein the circuitry is to adjust packet transmit rate by multiplicative decrease or increase based on a number of inflight bytes.

Example 15 includes one or more examples, wherein the circuitry is to adjust packet transmit rate by additive decrease or increase based on queue depth.

Example 16 includes one or more examples, wherein the adjust the packet transmit rate by additive decrease or increase based on queue depth is based on Explicit Congestion Notification (ECN) indications or smoothed queue depth and queue depth threshold.

Example 17 includes one or more examples, wherein the packet transmit rate is based on a congestion window size.

Example 18 includes one or more examples, wherein the network resource consumption data includes one or more of: queue depth, link utilization, or number of flows that provide packets to a congested queue.

Example 19 includes one or more examples, and includes a method comprising: adjusting a rate of packet transmissions by Explicit Congestion Notification (ECN)-based congestion control based on phase of operation and congestion metrics comprising queue depth at one or more intermediate switches.

Example 20 includes one or more examples, wherein the adjusting a congestion window size comprises adjusting the congestion window size by multiplicative decrease or increase based on a number of inflight bytes.

Example 21 includes one or more examples, wherein the adjusting a congestion window size comprises adjusting the congestion window size by additive decrease or increase based on queue depth.

What is claimed is:

1. An apparatus comprising:
a network interface device comprising:
circuitry to:
adjust a rate of packet transmissions by Explicit Congestion Notification (ECN)-based congestion control based on phase of operation and congestion metrics comprising queue depth at one or more intermediate switches.

2. The apparatus of claim 1, wherein the circuitry is to adjust the rate of packet transmissions by multiplicative decrease or increase based on a number of inflight bytes.

3. The apparatus of claim 1, wherein the circuitry is to adjust the rate of packet transmissions by additive decrease or increase based on congestion metric from the one or more intermediate switches at one or more intermediate switches.

4. The apparatus of claim 3, wherein the adjust the rate of packet transmissions by additive decrease or increase based on queue depth is based on Explicit Congestion Notification (ECN) indications or smoothed queue depth and queue depth threshold.

5. The apparatus of claim 1, wherein the circuitry is to fall back to Data Center TCP (DCTCP) congestion control based on unavailability of queue depth.

6. The apparatus of claim 1, wherein the rate of packet transmissions is based on a congestion window size.

7. The apparatus of claim 6, wherein the circuitry is to adjust the congestion window size based on a number of flows contributing to congestion.

8. The apparatus of claim 1, wherein the network resource consumption data includes one or more of: queue depth, link utilization, or number of flows that provide packets to a congested queue.

9. The apparatus of claim 1, wherein the phase of operation comprises slow start or congestion-avoidance phase.

10. The apparatus of claim 1, wherein the network interface device comprises one or more of: network interface controller (NIC), SmartNIC, router, forwarding element, infrastructure processing unit (IPU), or data processing unit (DPU).

11. The apparatus of claim 1, comprising a computing system coupled to the network interface device, wherein the computing system is to configure a congestion window size of the network interface device to adjust a rate of packet transmissions by DCTCP congestion control.

12. The apparatus of claim 1, comprising one or more switches to provide the congestion metrics at a frequency based on a number of flows contributing to congestion.

13. A computer-readable medium comprising instructions stored thereon, that if executed by one or more processors, cause the one or more processors to:
configure circuitry of a network interface device to:
adjust a rate of packet transmissions by Explicit Congestion Notification (ECN)-based congestion control based on phase of operation and congestion metrics comprising queue depth at one or more intermediate switches.

14. The computer-readable medium of claim 13, wherein the circuitry is to adjust packet transmit rate by multiplicative decrease or increase based on a number of inflight bytes.

15. The computer-readable medium of claim 13, wherein the circuitry is to adjust packet transmit rate by additive decrease or increase based on queue depth.

16. The computer-readable medium of claim 14, wherein the adjust the packet transmit rate by additive decrease or increase based on queue depth is based on Explicit Congestion Notification (ECN) indications or smoothed queue depth and queue depth threshold.

17. The computer-readable medium of claim 13, wherein the packet transmit rate is based on a congestion window size.

18. The computer-readable medium of claim 13, wherein the network resource consumption data includes one or more of: queue depth, link utilization, or number of flows that provide packets to a congested queue.

19. A method comprising:
adjusting a rate of packet transmissions by Explicit Congestion Notification (ECN)-based congestion control based on phase of operation and congestion metrics comprising queue depth at one or more intermediate switches.

20. The method of claim 19, wherein the adjusting a congestion window size comprises adjusting the congestion window size by multiplicative decrease or increase based on a number of inflight bytes.

21. The method of claim 19, wherein the adjusting a congestion window size comprises adjusting the congestion window size by additive decrease or increase based on queue depth.
